(19) United States
(12) Patent Application Publication
(10) Pub. No.: US 2023/0394637 A1
(43) Pub. Date: Dec. 7, 2023

(54) DECRYPTION-LESS PRIVACY PROTECTION USING A TRANSFORM IN THE IMAGER

(71) Applicant: SRI International, Menlo Park, CA (US)

(72) Inventors: David Chao ZHANG, Belle Mead, NJ (US); Michael A. ISNARDI, Plainsboro, NJ (US); Michael R. PIACENTINO, Robbinsville, NJ (US)

(21) Appl. No.: 18/206,001

(22) Filed: Jun. 5, 2023

Related U.S. Application Data
(60) Provisional application No. 63/349,404, filed on Jun. 6, 2022.

(51) Int. Cl. G06T 5/10; G06V 20/52

(52) U.S. Cl. CPC G06T 5/10; G06V 20/52; G06V 2201/07

(57) ABSTRACT

A method, apparatus and system for image privacy protection and actionable response includes distorting an analog image captured using an image capture device in a residential, industrial or commercial environment using a transform filter, digitizing the distorted analog image, analyzing the distorted, digitized image using a trained machine learning process to identify at least one of an individual or an object in the distorted, digitized image, the machine learning process having been trained to identify individuals and objections in the distorted image, and upon identification of at least one of an individual or an object in the distorted image for which action is to be taken, communicating an indication to at least one device in the residential, commercial or industrial environment to cause the device to perform a predetermined action.

### CROSS-REFERENCE TO RELATED APPLICATIONS

This application claims benefit of U.S. Provisional patent application Ser. No. 63/349,404 filed Jun. 6, 2022, which is herein incorporated by reference in its entirety.

### GOVERNMENT RIGHTS IN THIS INVENTION

This invention was made with U.S. Government support under Grant Number DEAR0000940 awarded by Department of Energy. The U.S. Government has certain rights in the invention.

### BACKGROUND OF THE INVENTION

### Field of the Invention

Embodiments of the present invention generally relate to privacy protection, and more specifically to protecting privacy related to digital imaging.

### Description of the Related Art

The use of cameras and imaging in home and commercial environments include many applications from security monitoring to using information of the captured images to control the environment. However, the use of cameras in such private or commercial environments give rise to privacy problems. More specifically, images and image information can be intercepted and people and objects in images can be identified.

In current applications, data encryption is used so that encoded images are no longer recognizable. To protect privacy, the encrypted images need to be processed without a decrypted key, so the data either on an edge device or being transferred to other edges or to the cloud does not reveal image data if intercepted. However, due to the size, weight, and power constraints of the edge devices, computing resources are limited and complicated encryption schemes cannot be applied in such devices. That is, current solutions are either not fully secured or too complex for low size, weight and power (SwaP}-constrained devices.

### SUMMARY OF THE INVENTION

Embodiments of the present principles provide methods, apparatuses and systems for image privacy protection and actionable response using distorted/scrambled images and image data without the need for providing decryption keys for detecting/identifying at least individuals and objects in the distorted/scrambled images.

In some embodiments, a method for image privacy protection and actionable response includes distorting a captured analog image using a transform filter, digitizing the distorted analog image, analyzing the distorted, digitized image using a trained machine learning process to identify at least one of an individual or an object in the distorted, digitized image, the machine learning process having been trained to identify individuals and/or objects in the distorted image, and upon identification of at least one of an individual or an object in the distorted image for which action is to be taken, communicating an indication to at least one device to cause the at least one device to perform a predetermined action.

In some embodiments, the method can further include determining a status of the at least one individual or object identified in the distorted image for which action is to be taken. In such embodiments, a predetermined action to be taken by the device can be dependent on the determined status of the at least one individual or object identified in the distorted image for which action is to be taken.

In some embodiments, the machine learning process of the method is trained to inverse-transform the distorted image and at least one of an individual or object can be identified from the inverse-transformed image.

In some embodiments, an apparatus for image privacy protection and actionable response include a processor and a memory accessible to the processor, the memory having stored therein at least one of programs or instructions executable by the processor. When executed, the programs or instructions configure the apparatus to analyze a digitized image distorted using a transform filter before the image was digitized, the distorted, digitized image being analyzed using a trained machine learning process to identify at least one of an individual or an object in the distorted, digitized image, the machine learning process having been trained to identify individuals and objects in the distorted image, and upon identification of at least one of an individual or an object in the distorted image for which action is to be taken, communicate an indication to at least one device to cause the device to perform a predetermined action.

In some embodiments, the apparatus is further configured to determine a status of the at least one individual or object identified in the distorted image for which action is to be taken. In such embodiments, a predetermined action to be taken by the device can be dependent on the determined status of the at least one individual or object identified in the distorted image for which action is to be taken.

In some embodiments of the apparatus, the machine learning process is trained to inverse-transform the distorted image and to identify individuals and objects in the inverse-transformed image.

In some embodiments, a system for image privacy protection and actionable response includes an image capture device including an imager, a transform filter, and an analog to digital converter. The system further includes a control unit including a processor and a memory accessible to the processor, the memory having stored therein at least one of programs or instructions executable by the processor. When executed, the programs or instructions configure the control unit to analyze an analog image captured using the imager, distorted using the transform filter, and digitized using the analog to digital converter, the distorted, digitized image being analyzed using a trained machine learning process to identify at least one of an individual or an object in the distorted, digitized image, the machine learning process having been trained to identify individuals and objects in the distorted image, and upon identification of at least one of an individual or an object in the distorted image for which action is to be taken, communicate an indication to at least one device to cause the device to perform a predetermined action.

In some embodiments the control unit is further configured to determine a status of the at least one individual or object identified in the distorted image for which action is to be taken and a predetermined action to be taken by the device is dependent on the determined status of the at least one individual or object identified in the distorted image for which action is to be taken.

In some embodiments of the system, in the control unit the machine learning process is trained to inverse-transform the distorted image and to identify individuals and objects in the inverse-transformed image.

In some embodiments of the present principles, the transform filter can include at least one of a Walsh-Hadamard transform or a Fourier transform.

In some embodiments, the analog image is captured using an image capture device located in at least one of a residential, a commercial, or an industrial environment.

In some embodiments, the at least one device is located in the at least one residential, commercial or industrial environment and the predetermined action performed by the at least one device causes a change to the at least one residential, commercial, or industrial environment.

In some embodiments, the machine learning process is applied at a receiver remote from a location of an image capture device used to capture the analog image.

Various advantages, aspects and features of the present disclosure, as well as details of an illustrated embodiment thereof, are more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a high-level block diagram of an imaging and control system in accordance with an embodiment of the present principles.

FIG. 2A depicts a pictorial representation of the application of the Hadamard transform to an image captured by an imaging device in accordance with an embodiment of the present principles.

FIG. 2B depicts an enlarged view of the distorted image in frame YH of FIG. 2A.

FIG. 3 depicts a flow diagram of a method for image privacy protection and actionable response in accordance with an embodiment of the present principles.

FIG. 4 a high-level block diagram of a receiver/control unit suitable for use within embodiments of an imaging and control system in accordance with the present principles.

FIG. 5 depicts a high-level block diagram of a network in which embodiments of an imaging and control system in accordance with the present principles can be implemented.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to privacy of digital images by providing distortion/scrambling of images and image data in SwaP-constrained devices without the need for providing decryption keys for detecting/identifying at least individuals and/or objects in the distorted/scrambled images. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to distorting images using specific image transformation techniques, embodiments in accordance with the present principles can be implemented with other transformation techniques for distorting images and image data in accordance with the present principles described herein.

In the present disclosure, the terms “distort”, “scramble”, “transform” and like derivative terms are intended to describe and define the manipulation of portions (e.g., pixels) of a captured image such that objects/images in the manipulated image are not perceivable by a human or on a display after manipulation. In some embodiments of the present principles, a distortion, scrambling or transformation of a captured image can include a rearrangement of individual or blocks (groups) of pixels of the captured image into different orders.

In the present disclosure, the phrases “reverse-transform image”, “inverse-transform image” and like derivative phrases are intended to describe and define an image that had been previously transformed, scrambled, and/or distorted and has since been manipulated to return the image to its original form/arrangement.

In the present disclosure, terms separated by hashes (e.g., indication/command/signal, detect/identify and the like) are intended to describe and define alternatives that can be implemented by embodiments of the present principles.

Embodiments of the present principles provide methods, apparatuses, and systems that provide privacy protection of digital images by, in some embodiments, using transform filters implemented before the image data captured by an image capture device is digitally converted. That is, in accordance with embodiments of the present principles, a transform filter can be applied to captured analog image data in an optical path of an image capture device, in some embodiments, right after an optical lens or in an analog circuit before captured image data gets digitized, to distort the captured image. Such configuration of the present principles prevents hacking of any raw data before communication or manipulation of the image data since the transform/distortion/scrambling of the image occurs before any digital conversion of image data by included analog to digital converters (ADCs). More specifically, a transform filter of the present principles distorts image data of a captured raw image and makes the distorted images unrecognizable. Although in some embodiments of the present principles described herein, after distortion of analog image data the image data is digitized, alternatively in some embodiments of the present principles, the distorted analog image can be communicated to a receiver of the present principles in analog form without being digitized. The distorted analog image data can then be processed and analyzed in accordance with the present principles.

In accordance with the present principles, a transformed image can be communicated to a receiver/control unit of the present principles for processing. At the receiver/control unit, a transformed image is analyzed to attempt to identify/detect at least an individual and/or object in the image. In some embodiments of the present principles, a machine learning process (i.e., a neural network) can be trained to be able to recognize individuals and/or objects in transformed images. Alternatively or in addition, in some embodiments of the present principles, a machine learning process can be trained to reverse the transform/distortion/scrambling of the image data to be able to analyze an inverse-transformed image to attempt to identify/detect at least an individual or object in the image (described in greater detail below). For example, in some embodiments of the present principles, image data distorted/scrambled by, for example a transform filter, can be inverse-transformed by a trained machine learning process, such as a neural network, for example in a receiver of the present principles to attempt to identify/detect at least an individual or object in the image.

Upon identification/detection of Individuals and/or objects by a receiver/control unit of the present principles, indications/commands/signals can be communicated to device(s) in at least an environment in which the image data was captured to cause the device(s) to take action or communicate with individuals or objects in the environment.

In some embodiments of the present principles, a transform filter to transform/distort/scramble images in accordance with the present principles can include a Walsh-Hadamard transform (WHT) that can distort image data before it is digitized. In such embodiments, the WHT can be used to protect privacy with a camera-based edge device. More specifically, the 2-D Hadamard transform is a linear transform that only contains +1 or −1 values. The transform effectively preserves information from an image source without loss. The Hadamard transform distorts a raw image and makes the image unrecognizable and thus provides protection to privacy. For embodiments of the present principles implementing a Hadamard transform, simulations have shown that retraining a machine learning process with inputs based on the Hadamard transform does not degrade the detection accuracy compared to the network without the transform. A WHT can be initialized as a function of random hardware parameters without the need to give out matrix information. In accordance with the present principles, the use of WHT or other filters with similar behavior can be used to protect privacy. For example, in accordance with some embodiments of the present principles, a Fourier Transform filter can be used to distort captured analog images as described above. In alternative embodiments, other linearly invertible filters that are 100% recoverable can be used. Feeding the transformed image data for downstream tasks does not degrade a performance of trained machine learning (ML) processes, and no decryption key is needed.

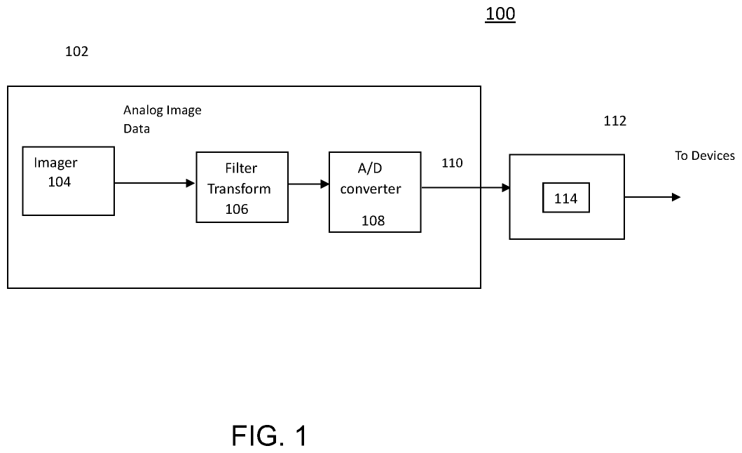

FIG. 1 depicts a high-level block diagram of an imaging and control system 100 in accordance with an embodiment of the present principles. The imaging and control system 100 of the present principles illustratively includes an image capture device 102 including an imager 104 for capturing images, a transform filter 106 for transforming the captured analog image data, an A/D converter 108 for digitizing the transformed image data, and an output 110. The imaging and control system 100 of FIG. 1, further illustratively includes a receiver/control unit 112.

In the embodiment of the imaging and control system 100 of FIG. 1, the capture device 102 can capture images of an environment in which the capture device 102 is located using the imager 104. For example, in some embodiments of the present principles, a capture device of the present principles, such as the capture device 102 of FIG. 1, can be located in at least one of a residential, commercial or industrial environment (not shown). The capture device 102 of the present principles can use the imager 104 in the environment to detect and monitor the presence of objects and/or individuals in the environment by capturing images of the objects and/or individuals.

The images captured by the imager 104 of the capture device 102 of the present principles, can then be transformed/distorted/scrambled by applying the transform filter 106 to the captured images. That is and as described above, a transform filter can be implemented in an optical path of the capture device 102, in some embodiments, right after an optical lens or alternatively in an analog circuit before the captured image data gets digitized. In some embodiments of the present principles, the transform filter 106 can comprise a Hadamard transform. More specifically, embodiments of the present principles can implement a Hadamard transform as a transform filter to transform/distort/scramble image data of captured, raw images. A n×n Hadamard matrix, H, has only 1's and −1's as coefficients. The Hadamard matrix, H, is its own transpose and its own (scaled) inverse, as depicted in equations one (1) and two (2), which follow:

H^{T}=H (1)

n·H⁻¹=H (2)

If X is a n×n image block (e.g., n=8, 16, 32 and so on), the 2D Hadamard transform can be represented according to equation three (3), which follows:

T=H*X*H, (3)

and the inverse 2D Hadamard transform can be represented according to equation four (4), which follows:

XR=H*T*H/n². (4)

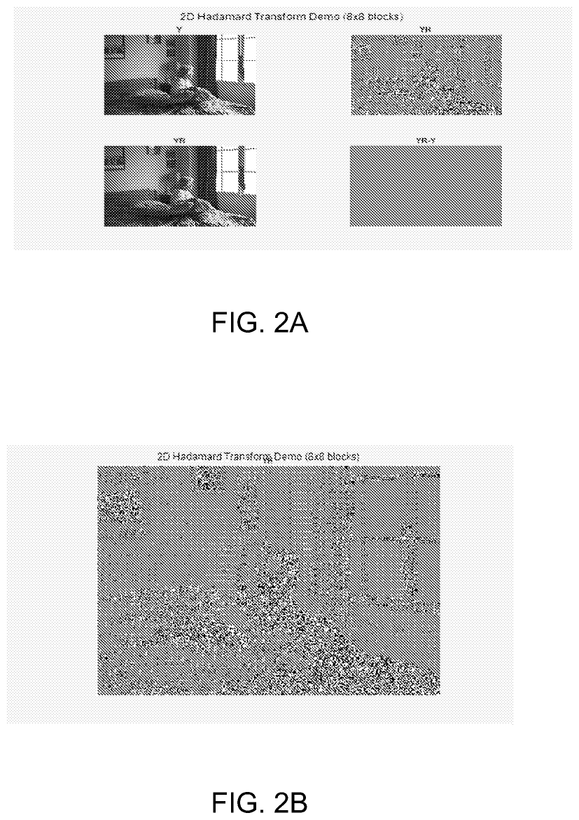

FIG. 2A depicts a pictorial representation of the application of the Hadamard transform to an image captured by an imaging device in accordance with an embodiment of the present principles. In FIG. 2A, the frame, Y, depicts a representation of the originally captured, monochrome image. The frame, YH, depicts a representation of the original image distorted by the application of a transform filter of the present principles, illustratively the Hadamard transform. In FIG. 2A, YR depicts a representation of an inverse of the transformed image frame, YH, having been inverse-transformed by, for example, a trained ML process including, for example a neural network, of the present principles (described in greater detail below). In the embodiment of FIG. 2A, the frame, YR-Y, depicts a representation of the differences between the originally captured image, Y, and the inverse-transformed image. As depicted in the frame, YR-Y of FIG. 2A, the transform and inverse-transform of the originally captured image, in accordance with the present principles, does not degrade the image.

FIG. 2B depicts an enlarged view of the distorted image in frame YH of FIG. 2A. In the embodiment of FIG. 2B, the original image is distorted using the Hadamard transform, having an 8×8 structure, such that the objects in the original image are unrecognizable to a human observer or on a display. In accordance with embodiments of the present principles, digital samples are synchronized to the block structure of the transform applied by a transform filter of the present principles (e.g., an 8×8 block will contain 8×8 RGB or monochrome samples). As depicted in FIG. 2B, the distorted image is unperceivable by the human eye.

Referring back to FIG. 1, in some embodiments, the distorted images can then be digitized by the A/D converter 108 of the capture device 102. The capture device 102 can output a digital video signal, to the receiver/control unit 112, that is either RGB or monochrome using the output 110 of the capture device 102. The digital samples are synchronized to the block structure of the transform applied by the transform filter 104 (e.g., an 8×8 block will contain 8×8 RGB or monochrome samples). That is, in some embodiments of the present principles, as a preprocessing step, video signals are converted to the number of color components and image size required by a machine learning (ML) process/neural network (NN) 114 of the receiver/control unit 112.

In accordance with some embodiments of the present principles, the transformed/distorted/scrambled digital RGB or monochrome image data can be communicated to the receiver/control unit 112 uncompressed over a wired or wireless communications channel. At the receiver/control unit 112 the trained ML process/neural network 114 is applied to attempt to identify/detect at least an individual and/or object in the image.

As described above, in some embodiments of the present principles, the ML process/neural network is trained to recognize individuals and/or objects in transformed/distorted/scrambled images. In such embodiments, the transformed image is never inverse-transformed and as such the privacy of the image is maintained throughout the processes of an imaging and control system of the present principles. As further described above, alternatively or in addition, in some embodiments, the ML process/neural network of the present principles is trained to inverse-transform the distorted image data to detect/identify images and/or objects from the inverse-transformed image data.

In accordance with the present principles, any neural network (NN) capable of processing image frames at video rates can be used in a receiver/control unit 112 of the present principles to analyze the image data. In some embodiments of the present principles, a pretrained network (e.g., Resnet50) can be used to begin the training of a ML process/NN of the present principles or, alternatively, a ML process/NN of the present principles can be trained from scratch.

For example, in some embodiments of the present principles, an imaging and control system of the present principles, such as the imaging and control system 100 of FIG. 1 can include a trained ML process implementing a NN for analyzing image data. For example, in some embodiments of the present principles, a receiver/control unit of the present principles, such as the receiver/control unit 112 of the imaging and control system 100 of FIG. 1, can include a ML process to evaluate and apply image data and distortion information for use in determining an ensemble of models in accordance with the present principles. In some embodiments, the ML process can include a multi-layer neural network comprising nodes that are trained to have specific weights and biases. In some embodiments, the ML process of, for example, receiver/control unit 112, employs artificial intelligence techniques or machine learning techniques to analyze image data and distortion information to analyze distorted data, and or to inverse-transform distorted/scrambled image data, to enable the identification of specific individuals and objects in captured image data. That is, in some embodiments, in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short Term Memory (LSTM) networks, Convolution Neural Networks (CNNs), graph neural networks applied to the abstract syntax trees corresponding to the sequential program application, and the like. In some embodiments a supervised ML classifier could be used such as, but not limited to, Multilayer Perceptron, Random Forest, Naive Bayes, Support Vector Machine, Logistic Regression and the like.

The ML process/NN of the present principles can be trained using thousands to millions of instances of originally captured image data and corresponding transformed/distorted image data to be used to generate models that can be compiled as an ensemble of models in accordance with the present principles. Over time, the ML process learns to look for specific attributes in the original image data and the transformed/distorted image data to determine an ensemble of models that can be used to identify individuals and/or objects in transformed data.

As described above, alternatively or in addition, in some embodiments of the present principles, ML process/NN of the present principles can be trained using thousands to millions of instances of originally captured image data and corresponding transformed/distorted image data to be used to generate models that look for specific attributes in the original image data and the transformed/distorted image data inverse-transform transform/distorted/scrambled images back to the original image to attempt to detect/identify individuals and/or objects in received images in accordance with the present principles.

In some embodiments of the present principles in which convolutional neural networks (CNNs) are used, it can be advantageous to match a stride of the initial transform layer to the block size (after any resizing) of the WHT. For example, if a 640×480 monochrome image is processed by an 8×8 WHT, and the NN accepts a 320×240 image, it can be advantageous to have a filter stride of 4×4 pixels, since the resized blocks are now 4×4. In such embodiments, features that are encoded within each block will remain within that block as the blocks are processed by an NN of the present principles, such as the NN 114 of the receiver/control unit 112.

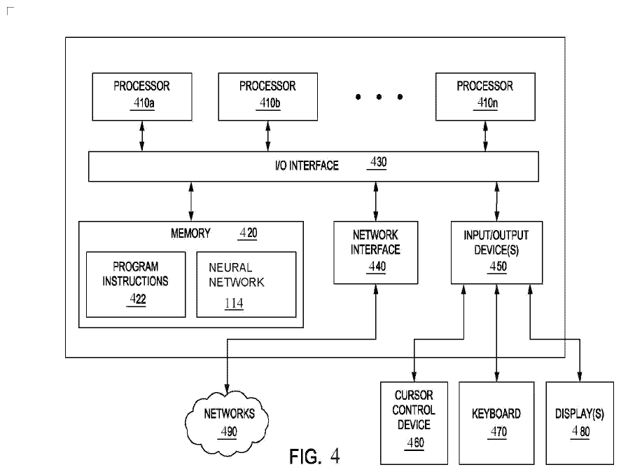

The images received by the receiver/control unit 112 are analyzed for detecting/identifying individuals and/or objects of interest. In accordance with the present principles, a receiver/control unit of the present principles can be configured to cause an action to occur upon the detection/identification of an individual and/or object in a received image. For example, in some embodiments of the present principles, rules/actions associated with individuals and/or objects can be stored in a storage/memory (not shown) accessible to a receiver/control unit of the present principles. In some embodiments of the present principles, information regarding the rules/actions can be input to a receiver/control unit of the present principles using input devices such as a keyboard, touchscreen, or software or hardware input buttons, a microphone, a pointing device and/or scrolling input component, such as a mouse, trackball or touch pad (described in greater detail with respect to FIG. 4). These and other input devices are often connected to the receiver/control unit of the present principles through a user input interface that is coupled to a system bus but can be connected by other interface and bus structures, such as a lighting port, game port, or a universal serial bus (USB).

Upon detection/identification of an individual and/or an object in received images, a receiver/control unit of the present principles, such as the receiver/control unit 112 of FIG. 1, can search a storage (not shown) in which rules/actions associated with specific individual and/or objects are stored to determine if any action should be taken as a result of the detection/identification of the individual and/or object in the digital image(s). In such embodiments of the present principles, upon identification of a rule/action to be taken that is associated with an individual/object that was identified in an image, a receiver/control unit of the present principles, such as the receiver/control unit 112 of FIG. 1, can communicate an indication/command/signal to a device in, for example, a residential, commercial and/or industrial environment in which an image capture device of the present principles, such as the image capture device 102 of FIG. 1, was located when capturing the images, to cause a device to take action as a result of the detection/identification of the individual and/or object in the image. In some embodiments of the present principles, the action to be taken by a respective device has been predetermined and an indication/command/signal communicated to the device by a receiver/control unit of the present principles is configured to cause the device to perform the predetermined action.

Alternatively or in addition, a receiver/control unit of the present principles can be aware (i.e., by storing such information in a local memory) of individuals and/or objects for which action is to be taken upon detection/identification of the individuals and/or objects in an image(s). In such embodiments of the present principles, upon detection/identification of an individual and/or object for which action is to be taken that was detected/identified in an image, a receiver/control unit of the present principles, such as the receiver/control unit 112 of FIG. 1, can communicate an indication/command/signal to a device in, for example, a residential, commercial and/or industrial environment in which an image capture device of the present principles, such as the image capture device 102 of FIG. 1, was located when capturing the images, to cause a device to take action as a result of the detection/identification of the individual and/or object in the image. In some embodiments of the present principles, the action to be taken by a respective device has been predetermined and an indication/signal/command communicated to the device by a receiver/control unit of the present principles is configured to cause the device to perform the predetermined action.

For example, upon detection/identification of a specific individual and/or object in an image by a receiver/control unit of the present principles, the receiver/control unit may communicate an indication/command/signal to at least one device in an environment, for example, in which the image was captured, to cause a change in the environment, such as a change in temperature, illumination, sound level, and the like. For example, in some embodiments, upon detection/identification of a known individual in an image, the receiver/controller of the present principles can communicate an indication/command/signal to at least one of a temperature controller, a light controller or a speaker controller in the environment, based on, for example, at least one of a known temperature, light level or sound level preferred by the detected/identified individual. In accordance with the present principles, a receiver/control unit of the present principles can communicate an indication/command/signal to substantially any device (e.g., IoT device) capable of communicating with the receiver/control unit.

In some embodiments of a system of the present principles, such as the imaging and control system 100 of FIG. 1, individuals and/or objects can be registered with the imaging and control system 100 and images of the individuals and/or objects can be identifiable by, for example, a receiver/control unit of the present principles. In such embodiments, predetermined actions can be associated with the registered individuals and/or objects. A system of the present principles is capable of detecting whether a room is occupied by a registered individual and/or object and not be fooled by other individuals, pets, or other moving objects such as rotating fans or robotic vacuums and the like. In accordance with the present principles, when a registered individual and/or object is detected/identified in an image by, for example, a receiver/control unit of the present principles, the receiver/control unit of the present principles can communicate an indication/command/signal to an accessible device in, for example, an environment in which the original image was captured, to cause the device to perform the predetermined action.

In some embodiments, a system of the present principles, such as the imaging and control system 100 of FIG. 1, via for example a receiver/control unit of the present principles is capable of determining a status of an individual and/or object from a received image. For example, in some embodiments, a ML process/NN of the present principles, such as the ML process/NN 114 of the receiver/control unit 112 of the imaging and process control system 100 of FIG. 1, can be trained to recognize a status and/or classify an activity (e.g., eating, reading, sleeping, moving, laying still etc.) of an individual and/or object in a distorted image. In some embodiments, the ML process/NN of the present principles can be trained using thousands to millions of instances of originally captured image data including labels of a status/activity of an individual and/or object, which can be used to generate models that can be compiled as an ensemble of models in accordance with the present principles. Over time, the ML process/NN of the present principles learns to look for specific attributes in the original image data identifying a status/activity of an individual and/or object in distorted image data.

In some embodiments of the present principles, an action to be performed by a device upon identification of at least one individual and/or object in a distorted image by a ML process/NN of a receiver/control unit of the present principles can be dependent upon a status of the identified individual and/or object in the distorted image. For example, if a status of an individual in a distorted image is determined by a ML process/NN of the present principles to be sleeping, the ML process/NN can communicate a signal to an alarm clock (e.g., a networked alarm clock) in the environment in which the identified individual is sleeping to ring an alarm bell at a time at which the individual should be awakened or just awake.

In some embodiments of the present principles, an imaging and control system of the present principles can be implemented to monitor an environment (e.g., residential, commercial, and/or industrial) and alert emergency services when necessary. For example, a receiver/control unit of the present principles can determine if an individual, for which action should be taken, has fallen or become injured and can communicate an indication/command/signal to a device in the environment to sound an alert or can alternatively or in addition, alert an emergency contact or emergency services.

In some embodiments of the present principles, an imaging and control system of the present principles can interact with an individual and/or object detected/identified in a distorted image. For example, in some embodiments, upon detection/identification of a participating individual and/or object in a distorted image, a receiver/control unit of the present principles can communicate a predetermined message to the individual and/or object, in some embodiments, based on a determined status of the individual and/or object in the distorted image.

Alternatively or in addition, in some embodiments of the present principles, a participating individual and/or object can communicate with an imaging and control system of the present principles. For example, an individual and/or object in, for example, a residential, commercial, or industrial environment can direct a communication to a capture device associated with, for example, a receiver/control unit of the present principles. Upon detection/identification of the individual and/or object that originated the communication, a receiver/control unit of the present principles can determine if the individual and/or object that originated the communication is a participant in the imaging and control system of the present principles. If the individual and/or object that originated the communication is a participant in the imaging and control system, a receiver/control unit of the present principles can interpret the communication and provide a response to the individual and/or object that originated the communication using a communication device accessible by the individual and/or object that originated the communication. For example, in some embodiments, a receiver/control unit of the present principles can provide a response to the individual and/or object that originated the communication using a display device and/or a speaker in the environment in which individual and/or object that originated the communication is located. In such embodiments, a receiver/control unit of the present principles, such as the receiver/control unit 112 of the imaging and control system 100 of FIG. 1, can implement a machine learning process, such as the ML process 114, to implement Natural language processing to accept the communication from the individual and/or object, interpret the communication, and make sense of the communication in a way that the receiver/control unit can understand, whether the communication was spoken or written. In such embodiments, a receiver/control unit of the present principles can receive the communication from the individual and/or object via a speaker and/or camera accessible to the individual and/or object.

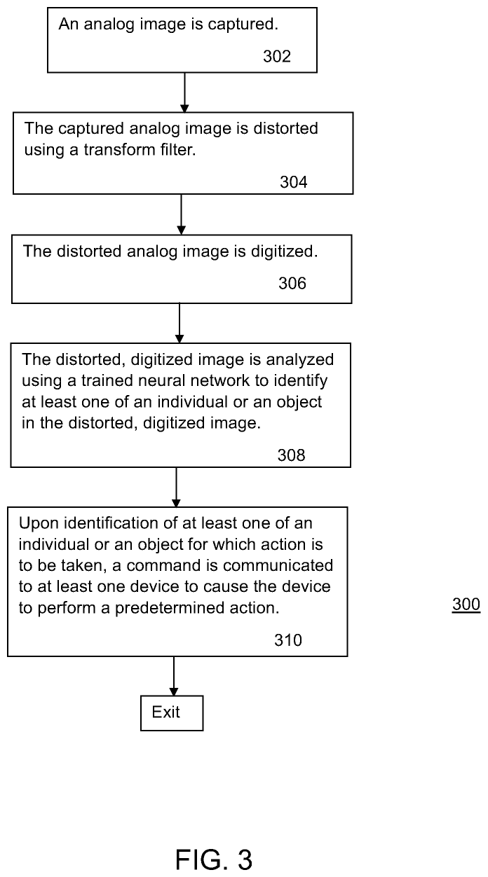

FIG. 3 depicts a flow diagram of a method 300 for image privacy protection and actionable response in accordance with an embodiment of the present principles. The method 300 begins at 302 during which an analog image is captured using for example an imager of an image capture device. The method 300 can proceed to 304.

At 304, the captured analog image is distorted using a transform filter. The method 300 can proceed to 304.

At 306, the distorted analog image is digitized. The method 300 can proceed to 308.

At 308, the distorted, digitized image is analyzed using a trained ML process, for example including a neural network, to identify at least one of an individual or an object in the distorted, digitized image. As described above, a ML process of the present principles is trained to recognize at least one of an individual or an object in distorted image(s). The method 300 can proceed to 310.

At 310, upon identification of at least one of an individual or an object for which action is to be taken, an indication is communicated to at least one device to cause the device to perform a predetermined action. The method 300 can then be exited.

FIG. 4 depicts a high-level block diagram of a receiver/control unit 112 suitable for use within embodiments of an imaging and control system in accordance with the present principles such as the imaging and control system 100 of FIG. 1. In some embodiments, the receiver/control unit 112 can be configured to implement methods of the present principles as processor-executable executable program instructions 422 (e.g., program instructions executable by processor(s) 410) in various embodiments.

In the embodiment of FIG. 4, the receiver/control unit 112 includes one or more processors 410a-410n coupled to a system memory 420 via an input/output (I/O) interface 430. The receiver/control unit 112 further includes a network interface 440 coupled to I/O interface 430, and one or more input/output devices 450, such as cursor control device 460, keyboard 470, and display(s) 480. In various embodiments, a user interface can be generated and displayed on display 480. In some cases, it is contemplated that embodiments can be implemented using a single instance of receiver/control unit 112, while in other embodiments multiple such systems, or multiple nodes making up the receiver/control unit 112, can be configured to host different portions or instances of various embodiments. For example, in one embodiment some elements can be implemented via one or more nodes of the receiver/control unit 112 that are distinct from those nodes implementing other elements. In another example, multiple nodes may implement the receiver/control unit 112 in a distributed manner.

In different embodiments, the receiver/control unit 112 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the receiver/control unit 112 can be a uniprocessor system including one processor 410, or a multiprocessor system including several processors 410 (e.g., two, four, eight, or another suitable number). Processors 410 can be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 can be configured to store program instructions 422 and/or, in some embodiments, the NN 114 accessible by processor 410. In various embodiments, system memory 420 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 420. In other embodiments, program instructions and/or data can be received, sent or stored upon different types of computer-accessible media or on similar media separate from system memory 420 or the receiver/control unit 112.

In one embodiment, I/O interface 430 can be configured to coordinate I/O traffic between processor 410, system memory 420, and any peripheral devices in the device, including network interface 440 or other peripheral interfaces, such as input/output devices 450. In some embodiments, I/O interface 430 can perform any necessary protocol, timing or other data transformations to convert data signals from one component (e.g., system memory 420) into a format suitable for use by another component (e.g., processor 410). In some embodiments, I/O interface 430 can include support for devices attached through various types of peripheral buses, such as a variant of the Peripheral Component Interconnect (PCI) bus standard or the Universal Serial Bus (USB) standard, for example. In some embodiments, the function of I/O interface 430 can be split into two or more separate components, such as a north bridge and a south bridge, for example. Also, in some embodiments some or all of the functionality of I/O interface 430, such as an interface to system memory 420, can be incorporated directly into processor 410.

Network interface 440 can be configured to allow data to be exchanged between the receiver/control unit 112 and other devices attached to a network (e.g., network 490), such as one or more external systems or between nodes of the receiver/control unit 112. In various embodiments, network 490 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 450 can, in some embodiments, include one or more display terminals, keyboards, keypads, touchpads, scanning devices, voice or optical recognition devices, or any other devices suitable for entering or accessing data by one or more computer systems. Multiple input/output devices 450 can be present in computer system or can be distributed on various nodes of the receiver/control unit 112. In some embodiments, similar input/output devices can be separate from the receiver/control unit 112 and can interact with one or more nodes of the receiver/control unit 112 through a wired or wireless connection, such as over network interface 440.

Those skilled in the art will appreciate that the receiver/control unit 112 is merely illustrative and is not intended to limit the scope of embodiments. In particular, the receiver/control unit and peripheral devices can include any combination of hardware or software that can perform the indicated functions of various embodiments, including computers, network devices, Internet appliances, PDAs, wireless phones, pagers, and the like. The receiver/control unit 112 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The receiver/control unit 112 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The receiver/control unit 112 can further include a web browser.

Although the receiver/control unit 112 is depicted as a general purpose computer, the receiver/control unit 112 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

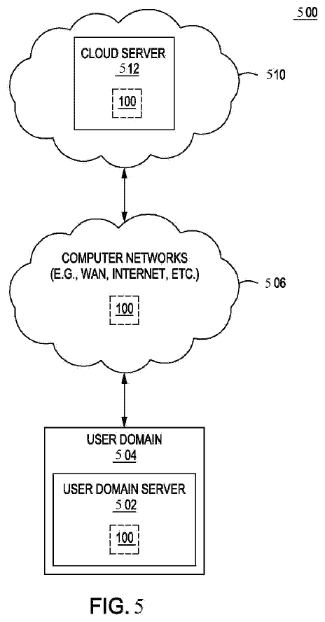

FIG. 5 depicts a high-level block diagram of a network in which embodiments of an imaging and control system 100 in accordance with the present principles such as the imaging and control system 100 of FIG. 1, can be implemented. The network environment 500 of FIG. 5 illustratively comprises a user domain 502 including a user domain server/computing device 504. The network environment 500 of FIG. 5 further comprises computer networks 506, and a cloud environment 510 including a cloud server/computing device 512.

In the network environment 500 of FIG. 5, an imaging and control system in accordance with the present principles such as the imaging and control system 100 of FIG. 1, can be included in at least one of the user domain server/computing device 504, the computer networks 506, and the cloud server/computing device 512. That is, in some embodiments, a user can use a local server/computing device (e.g., the user domain server/computing device 504) to provide privacy of captured images and actionable response to the distorted images in accordance with the present principles. In some embodiments, a user can implement an imaging and control system in accordance with the present principles such as the imaging and control system 100 of FIG. 1 in the computer networks 506 to provide image privacy and actionable response to the distorted images in accordance with the present principles. Alternatively or in addition, in some embodiments, a user can provide an imaging and control system of the present principles in the cloud server/computing device 512 of the cloud environment 510. For example, in some embodiments it can be advantageous to perform processing functions of the present principles in the cloud environment 510 to take advantage of the processing capabilities and storage capabilities of the cloud environment 510.

In some embodiments in accordance with the present principles, an imaging and control system in accordance with the present principles can be located in a single and/or multiple locations/servers/computers to perform all or portions of the herein described functionalities of a system in accordance with the present principles. For example, in some embodiments some components of the imaging and control system of the present principles, such as the capture device 102 and the receiver/control unit 112, can be located in one or more than one of the user domain 502, the computer network environment 506, and the cloud environment 510 for providing the functions described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from a computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

While the foregoing is directed to embodiments of the present invention, other and further embodiments of the invention may be devised without departing from the basic scope thereof, and the scope thereof is determined by the claims that follow.

1. A method for image privacy protection and actionable response, comprising:
distorting a captured analog image using a transform filter;
digitizing the distorted analog image;
analyzing the distorted, digitized image using a trained machine learning process to identify at least one of an individual or an object in the distorted, digitized image, the machine learning process having been trained to identify individuals and objects in the distorted image; and
upon identification of at least one of an individual or an object in the distorted, digitized image for which an action is to be taken, communicating an indication to at least one device to cause the at least one device to perform a predetermined action.

2. The method of claim 1, wherein the transform filter comprises at least one of a Walsh-Hadamard transform or a Fourier transform.

3. The method of claim 1, wherein the analog image is captured using an image capture device located in at least one of a residential, a commercial, or an industrial environment.

4. The method of claim 3, wherein the at least one device is located in the at least one residential, commercial or industrial environment and the predetermined action performed by the at least one device causes a change to the at least one residential, commercial, or industrial environment.

5. The method of claim 1, further comprising:
determining a status of the at least one individual or object identified in the distorted, digitized image for which action is to be taken.

6. The method of claim 5, wherein a predetermined action to be taken by the device is dependent on the determined status of the at least one individual or object identified in the distorted, digitized image for which action is to be taken.

7. The method of claim 1, wherein the machine learning process is trained to inverse-transform the distorted image and to identify individuals and objects in the inverse-transformed image.

8. An apparatus for image privacy protection and actionable response, comprising:
a processor; and
a memory accessible to the processor, the memory having stored therein at least one of programs or instructions executable by the processor to configure the apparatus to:
analyze a digitized image distorted using a transform filter before the image was digitized, the distorted, digitized image being analyzed using a trained machine learning process to identify at least one of an individual or an object in the distorted, digitized image, the machine learning process having been trained to identify individuals and objects in the distorted image; and
upon identification of at least one of an individual or an object in the distorted, digitized image for which action is to be taken, communicate an indication to at least one device to cause the at least one device to perform a predetermined action.

9. The apparatus of claim 8, wherein the transform filter comprises at least one of a Walsh-Hadamard transform or a Fourier transform.

10. The apparatus of claim 8, wherein the analog image is captured using an image capture device located in at least one of a residential, a commercial, or an industrial environment.

11. The apparatus of claim 10, wherein the at least one device is located in the at least one residential, commercial, or industrial environment and the predetermined action performed by the at least one device causes a change to the at least one residential, commercial, or industrial environment.

12. The apparatus of claim 8, wherein the apparatus is further configured to:
determine a status of the at least one individual or object identified in the distorted, digitized image for which action is to be taken.

13. The apparatus of claim 12, wherein a predetermined action to be taken by the device is dependent on the determined status of the at least one individual or object identified in the distorted, digitized image for which action is to be taken.

14. The apparatus of claim 8, wherein the machine learning process is trained to inverse-transform the distorted image and to identify individuals and objects in the inverse-transformed image.

15. A system for image privacy protection and actionable response, comprising:
an image capture device, comprising:
an imager;
a transform filter; and
an analog to digital converter;
and
a control unit, comprising;
a processor; and
a memory accessible to the processor, the memory having stored therein at least one of programs or instructions executable by the processor to configure the control unit to:
analyze an analog image captured using the imager, distorted using the transform filter, and digitized using the analog to digital converter, the distorted, digitized image being analyzed using a trained machine learning process to identify at least one of an individual or an object in the distorted, digitized image, the machine learning process having been trained to identify individuals and objects in the distorted, digitized image; and
upon identification of at least one of an individual or an object in the distorted, digitized image for which action is to be taken, communicate an indication to at least one device to cause the at least one device to perform a predetermined action.

16. The system of claim 15, wherein the transform filter comprises at least one of a Walsh-Hadamard transform or a Fourier transform.

17. The system of claim 15, wherein the image capture device is located in at least one of a residential, a commercial, or an industrial environment.

18. The system of claim 17, wherein the at least one device is located in the at least one residential, commercial, or industrial environment and the predetermined action performed by the at least one device causes a change to the at least one residential, commercial, or industrial environment.

19. The system of claim 15, wherein the control unit is further configured to:
determine a status of the at least one individual or object identified in the distorted, digitized image for which action is to be taken and a predetermined action to be taken by the device is dependent on the determined status of the at least one individual or object identified in the distorted, digitized image for which action is to be taken.

20. The system of claim 15, wherein the machine learning process is trained to inverse-transform the distorted image and to identify individuals and objects in the inverse-transformed image.
